(19) United States
(12) Patent Application Publication
(10) Pub. No.: US 2017/0032263 A1
(43) Pub. Date: Feb. 2, 2017

(54) METHODS AND SYSTEMS FOR CONTEXT DRIVEN INFORMATION SERVICES AND ADVANCED DECISION MAKING

(71) Applicant: THE BOEING COMPANY, Huntington Beach, CA (US)

(72) Inventors: Jun Yuan, Sammamish, WA (US); Ali Bahrami, Sammamish, WA (US)

(21) Appl. No.: 14/809,573

(22) Filed: Jul. 27, 2015

(51) Int. Cl. G06N 5/04

(52) U.S. Cl. CPC G06N 5/045

(57) ABSTRACT

A computer-implemented method for collating relevant information to assist a user in a decision-making process is provided. The method includes receiving, from a plurality of data sources, a plurality of pieces of data including contextual features, and populating at least one contextual model with the plurality of pieces of data. The at least one contextual model groups pieces of data based at least in part on the contextual features. The method also includes calculating one or more contextual relationships based on the at least one contextual model, and determining one or more pieces of data of the at least one contextual model to provide to a user based on the one or more contextual relationships and one or more decision making rules.

### BACKGROUND

The field of the present disclosure relates generally to providing contextual information and, more specifically, to collating relevant information to assist a user in a decision-making process.

The massive amount of data available today is placing unprecedented demands on the ability of human agents to solve complex problems and achieve common goals within shortened decision-making time scales. This is founded by the continued growth in the types of data, particularly “soft” information data with limited structure, available to decision makers. In order to support distributed information processing for decision making, a feasible method is required to transform disparate information into relevant knowledge and to speed up the decision making process with more intelligence and accuracy.

Information systems are able to provide staggering amounts of information; however, context surrounding the information is required to bring this information into focus and be properly processed. Examples of context information include: location, identity, time, and activity. Context answers fundamental questions such as what is occurring in the situation, where one is, with whom one is, and what objects are around. Additionally, context refers to current values of specific data objects that represent a user's activity or situation.

The ability to hand off the information to others to properly make informed decisions based on the information is necessary, or the vital pieces of information and time will be lost as the decision makers come up to speed. The more contextual information that is provided, the more complete the picture of the situation will be.

For example, humanitarian efforts in disaster zones, such as after an earthquake, require quick and informed decision making to assist people as expeditiously as possible. Additionally, even with multiple sources of data, time is critical, and having as complete as picture as possible and being able to share it with as many people as quickly as possible is vital to saving lives.

### BRIEF DESCRIPTION

In one aspect, a computer-implemented method for collating relevant information to assist a user in a decision-making process is provided. The method is implemented using a contextual information collating (CIC) server system in communication with a memory. The method includes receiving, from a plurality of data sources, a plurality of pieces of data including contextual features, and populating at least one contextual model with the plurality of pieces of data. The at least one contextual model groups pieces of data based at least in part on the contextual features. The method also includes calculating, by the CIC server system, one or more contextual relationships based on the at least one contextual model, and determining, by the CIC server system, one or more pieces of data of the at least one contextual model to provide to a user based on the one or more contextual relationships and one or more decision making rules.

In another aspect, a contextual information collating (CIC) server system used to collate relevant information to assist a user in a decision-making process is provided. The CIC server system includes a processor coupled to a memory device. The processor is programmed to receive, from a plurality of data sources, a plurality of pieces of data including contextual features, and populate at least one contextual model with the plurality of pieces of data. The at least one contextual model groups pieces of data based at least in part on the contextual features. The processor is also programmed to calculate one or more contextual relationships based on the at least one contextual model, and determine one or more pieces of data of the at least one contextual model, which is provided to a user based on the one or more contextual relationships and one or more decision making rules.

In yet another aspect, at least one non-transitory computer-readable storage media having computer-executable instructions embodied thereon is provided. When executed by at least one processor, the computer-executable instructions cause the at least one processor to receive, from a plurality of data sources, a plurality of pieces of data including contextual features, and populate at least one contextual model with the plurality of pieces of data. The at least one contextual model groups pieces of data based at least in part on the contextual features. The computer-executable instructions also cause the at least one processor to calculate one or more contextual relationships based on the at least one contextual model, and determine one or more pieces of data of the at least one contextual model to provide to a user based on the one or more contextual relationships and one or more decision making rules.

### BRIEF DESCRIPTION OF THE DRAWINGS

FIG. 1 illustrates an example overview of a system for collating relevant information to assist a user in a decision-making process in accordance with one embodiment of the present disclosure.

FIG. 2 is a simplified block diagram of a system of devices for collating relevant information to assist a user in a decision-making process in accordance with one embodiment of the present disclosure.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for collating relevant information to assist a user in a decision-making process using the system shown in FIG. 1 and the system shown in FIG. 2.

### DETAILED DESCRIPTION

The implementations described herein relate to systems and methods for collating relevant information to assist a user in a decision-making process. More specifically, a contextual information collating (“CIC”) computer system receives a plurality of data from a plurality of data sources. The plurality of data includes real-time data and further includes contextual features. The CIC computer system generates one or more extensible contextual models with the plurality of data including the contextual features. In the example embodiment, the one or more extensible contextual models are previously generated and the CIC computer system uses the plurality of data to update the one or more extensible contextual models. The CIC computer system generates a higher level contextual model from the original (or lower level) contextual model. In the example embodiment, the CIC computer system generates the higher level contextual model based on the extensible contextual model without directly accessing the raw data from the plurality of data sources. The CIC computer system determines one or more contextual relationships between data points (also known as data artifacts) based on the higher level contextual model. Contextual relationships may be real-time spatial relationships such as distance or travel time between two individuals or units. The CIC computer system determines the information that needs to be provided to the user based on a predicting which pieces of information are important to the user's decision-making process. The CIC computer system provides the predicted context-enriched data to the user that is originally based on the real-time data received from the plurality of data sources.

Described herein are computer systems such as the CIC computer system and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, big data clusters (e.g. Hadoop clusters), NO-SQL data platforms, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and processes are not limited to the specific embodiments described herein. In addition, components of each system and each process can be practiced independent and separate from other components and processes described herein. Each component and process also can be used in combination with other assembly packages and processes.

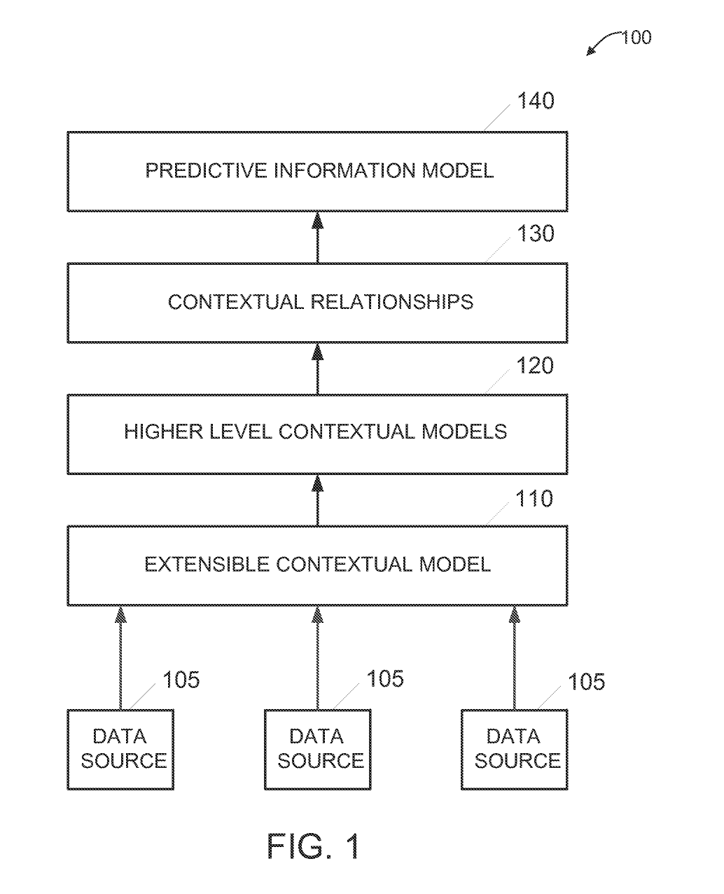

FIG. 1 illustrates an example overview of a system 100 for collating relevant information to assist a user in a decision-making process in accordance with one embodiment of the present disclosure. In the example embodiment, system 100 includes a plurality of data sources 105 that collect data in real-time. Data sources 105 may include but, are not limited to, sensors, reports from human agents, and databases. Data sources 105 may provide both historical data as well as data in real-time. Data provided by data sources 105 may be hard or soft information. Hard information includes facts, statistics, and raw data. Soft data includes rumors, opinions, and anecdotes. Combining hard and soft data so that they may be collated requires contextual information to determine how the information is related or relevant.

Contextual information can be defined as any information that can be used in the realization of meaning of an entity for a given information consumer, or to characterize the situation of an entity; where an entity can be a person, place, or physical or computational object. There are certain types of context that are, in practice, more basic than others (e.g. location, identity, and time), which can be categorized as primary contexts. Other types of context (e.g. where one is, with whom one is, and what objects are around) may be derived from primary contexts, and are called secondary or derivative contexts.

The relationships among information artifacts are dynamically influenced by their contexts. For example, by specifying the location of an entity, multiple information artifacts can be retrieved and aggregated in real time, including capabilities, movements, logistic demands or damage assessments of friendly/hostile units. Such aggregation can then reveal further opportunities, help to mitigate risk, provide early warnings or indicate how mission-planning alterations may impact upon other tasks or objectives.

Applying the context to system 100, allows system 100 to sense, interpret, and react to changes in the environment in which a user is situated. For example, a particular information entity co-exists together with other information entities in a given information space. Given the particular information entity, its contextual background usually shapes the meaning and the value of the particular information entity, as well as any correlations the particular information entity may share with the other information entities. In order to manage information along with its meanings, values, and correlations with other entities, an appropriate contextual environment of an information entity is characterized in some manner.

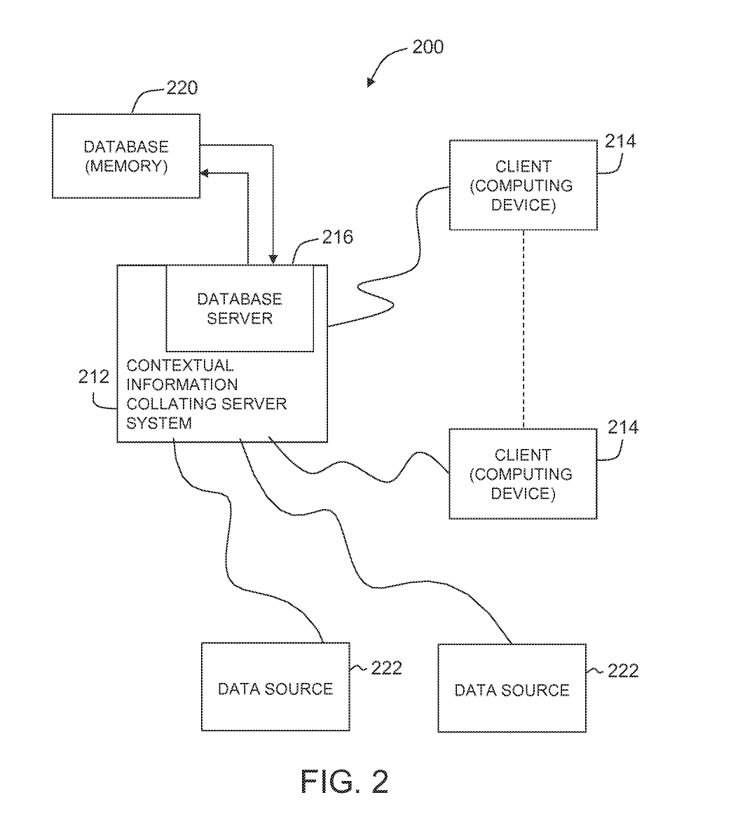

Entity context characterizes an entity, and entity is represented by two types of entity features, namely, data and context. Such entity characterizations include, but are not limited to, entity identity, entity type, time, location and activity. As implied in the preceding sentence, other types of context may be included. Entity contextual features are dynamic and assumed to be constantly changing and therefore may not be persistently stored in a database. However, without losing any generality, and for simplicity, it is assumed entity contextual features are stored in a persistent data repository, such as database 220 shown in FIG. 2.

The plurality of data from data sources 105 is used to generate or update an extensible contextual model 110. In the example embodiment, extensible contextual model 110 is a pre-generated model that is constantly being updated with the latest data from data sources 105. Extensible contextual model 110 is a contextual modeling mechanism that can incorporate, correlate and transform dynamic contextual facts, such as temporal-spatial characteristics, as well as mission-relevant information, among different models and data instances. Different types of context are represented by one or more models, for example, by ontologies and/or lower-level data structures. The choice of an appropriate contextual model may vary among different information providers and information consumers. A combined model provides easy correlation, conversion, and derivation between one and another.

Different types of context are represented by one or more models. For example, location context may be expressed as a geometric model representing location as an n-dimensional space and a symbolic model representing location using logical real-world entities such as buildings, streets, cities, or system-defined elements like economic zones. System 100 provides a contextual meta-model mechanism, which leverages many existing contextual ontologies (e.g. time, location, workflow, etc.), with mappings and conversions represented by both ontological predicates and pluggable reasoning services. These services calculate information relationships (e.g. real-time spatial relationships such as distance/travel time between two units) and compose new information objects that merge multiple existing information objects together.

In the example embodiment, the contextual meta-model mechanism works with existing contextual ontologies (e.g. time, location, mission planning, etc.) and provides mapping among one and another. System 100 leverages existing capabilities of mappings between ontologies and lower-level data structures, and further generates a generic contextual model management/mapping formalism to import existing models, enrich the semantic understanding of contextual content, capture contextual alignments, and perform progressive amendment in response to the dynamically changing environment.

The meaning of various contextual data is usually hidden or highly embedded in various data systems. This is one of the major barriers for a truly shared understanding among information consumers. System 100 integrates ontologies and algorithms to enrich the semantics of contextual content, by means of tagging data models and data instances with contextual ontologies. Our tagging and mapping mechanism provides varying degrees of domain-customized generality (e.g. conceptual grouping) and specialization (e.g. approximation via uncertainty) to deal with the dynamically changing information space.

The “noisy” factor of original data entry, such as errors, duplicates, and missing values (e.g. sensor readings) may invalidate existing contextual mappings and further cause failure of reasoning engine to derive secondary context. New information sources may also join constantly, and the new data may not fit well with existing mappings. To address this issue, system 100 includes features such as conditional contextual alignments, uncertainties of contextual similarity, and entity resolution specifics into the contextual mapping mechanism, as well as developing alignment integrity and consistency checking axioms for real-time alignment, validation and progressive amendment in response to changes and exceptions. This approach uses semantic rules to compose/decompose existing alignments within a hierarchical structure, as well as append/relax alignment conditions and/or confidence levels for approximations, to greatly increase the adaptability and reliability of context data management and dissemination in dynamic environments.

The information producer's (data sources 105) and consumer's roles potentially may vary greatly under various circumstances and contexts. Each agent takes a role in handling the context where importance is indicated by the priority. Extensible contextual model 110 may also apply “user-centric” confidence values (i.e. depicting the relevancy to a particular task/mission) to low-level contextual facts, which can be propagated to high-level contextual information according to the specific roles that different information producers/consumers are playing in order to improve the effectiveness and efficiency of contextual reasoning capability.

At the next level, system 100 includes a reasoning capability to infer higher-level knowledge (e.g. values, implications, ‘what if changed’ assumptions, hypotheses, etc.) about context from lower-level contextual properties, which can be derived from available data or low-level information sources (e.g. sensors) distributed across the network. In a heterogeneous environment with massive amount of data, effective contextual modeling and reasoning are important for implicit contexts are to be represented so as to enable distributed reasoning, decision making and collaboration.

For example, when mission planning artifacts are bound by temporal constraints (e.g. make a decision within 15 minutes) and information resource limit (e.g. UAV route and camera settings to derive UAV coverage), it can improve the timeliness of decision making while reducing resource consumption.

The effectiveness of existing approaches for distributed reasoning significantly degrades when scale goes up. To address this, system 100 includes a novel layered contextual model, in which at least one higher level contextual model 120 can be inferred from lower-level contextual models, such as extensible contextual model 110, as well as distributed reasoning based on priority. The layered contextual modeling is based on multidimensional space. In the lowest layer, extensible contextual model 110 is inferred from the original context information provided by data sources 105. While the higher level contextual model 120 is inferred from the adjacent lower layer, without using the original context information. The proposed reasoning will not involve all the agents' perspectives, but only the highly relevant ones based on priority.

Additionally, system 100 includes a mechanism for integrating differences in the roles of the data sources 105. If the priority of a data source 105 is low, its contribution in the merged model will be small and less resources will be spent on updating its context information. Therefore, system 100 decreases the amount of network traffic that system 100 needs to process. Furthermore, this approach makes system 100 more stable and flexible in context adaptation. In the some embodiments, system 100 receives confidence value (also known as a confidence score) for the different data sources from the end user (the one making the decision).

The “user-centric” confidence values can increase the trust and stability of distributed reasoning within merged contextual models. If the priority of a data source 105 is low based on its confidence value, then fewer resources may be used for updating its information. Furthermore, only when data source's 105 contributions are greater than certain thresholds (i.e. derived from a predictive information model 140 of decision making and behavioral analysis), information will be processed to improve the resource optimization in distributed reasoning. Hence, the resources used to update data sources' 105 context information will be reduced, thereby, making context adaptation more stable and flexible, especially in a competing and resource-constrained networked environment.

On top of extensible contextual model 110 and higher level contextual models 120, system 100 includes contextual relationships 130. Contextual relationships 130 are real-time spatial relationships, such as distance/travel time between two units. Contextual relationships 130 are determined through methods that dynamically link, group, aggregate, and merge contextually relevant information, and calculate its contextual relationships 130. These methods include ontological predicates and pluggable reasoning services, to bind various contextual realities as additional query filters to leverage existing information-retrieval and database-querying capabilities. These services calculate contextual relationships 130, and are also able to compose new information artifacts that merge multiple existing artifacts together.

System 100 also includes predictive information model 140 to assess the effectiveness of context-aware information services derived from the above activities, and thus to predict information needs for decision makers due to various types of ambiguity and uncertainty. Predictive information model 140 is derived from theories of team collaboration with respect to the information sense making. Predictive information model 140 is adapted based on how team members arrive at a shared interpretation of ambiguous, uncertain or conflicting situations, with help of various types of contextual information objects. Such contextual information represents the information needs. Predictive information model 140 identifies meta and macro information interpretation processes, human collaborative decision making stages, and features of decision making environments associated with effective decision making. In predictive information model 140, the decision making effectiveness is measured by performance metrics that are tightly associated with the contextual models 110 and 120. Predictive information model 140 aligns “end-user” requirements and preferences with the decision making process to reduce the information cognitive burden placed on decision makers, in terms of getting the right information at the right time.

Predictive information model 140 binds contextual relevancy to predictive information management services to infer and/or anticipate future information needs (e.g. to re-task UAV based on the current mission execution), and, when coupled to Network Quality of Service (QoS), such as ad-hoc network topologies (e.g. to pre-fetch information to mobile devices based on network availability and bandwidth restriction), to improve the timeliness of relevant information while reducing network consumption.

FIG. 2 is a simplified block diagram of a system of devices 200 for collating relevant information to assist a user in a decision-making process in accordance with one embodiment of the present disclosure. System 200 includes a contextual information collating (“CIC”) server system 212 configured to collate relevant information to assist a user in a decision-making process. In some embodiments, CIC server system 212 may be a single device as shown in FIG. 2. In other embodiments, CIC server system 212 is a collection of server devices that are connected to share information and processing. As described below in more detail, CIC server system 212 is configured to receive a plurality of current data from a plurality of data sources 222 (also known as data sources 105 shown in FIG. 1) including contextual features, populate at least one contextual model with the plurality of data, wherein the at least one contextual model groups pieces of data based at least in part on the contextual features, calculate one or more contextual relationships based on the contextual model, and determine one or more pieces of data of the at least one contextual model, which is provided to a user based on the one or more contextual relationships and one or more decision making rules.

System 200 includes client systems 214 (also known as client device 214) which are in communication with a user. In the example embodiment, client systems 214 are computers that include a web browser or a software application, which enables client systems 214 to access CIC server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 220 that stores data. In some embodiments, database 220 may also be a datastore. In one embodiment, database 220 includes data from data sources 222, contextual models 110, 120, contextual relationships 130 (shown in FIG. 1), and predictive information model 140 (shown in FIG. 1). In the example embodiment, database 220 is stored remotely from CIC server system 212. In some embodiments, database 220 is decentralized. In the example embodiment, a person can access database 220 via client systems 214 by logging onto CIC server system 212, as described herein.

One or more data sources 222 are communicatively coupled with CIC server system 212. As described in detail below, the one or more data sources 222 provide information in real-time. Data sources 222 include any method or device that may provide up-to-date information to CIC server system 212. Examples of data sources may include, but are not limited to, may include but, are not limited to, sensors, reports from human agents, databases, and any other source of information that provides information to CIC server system 212 that allows it to operate as described.

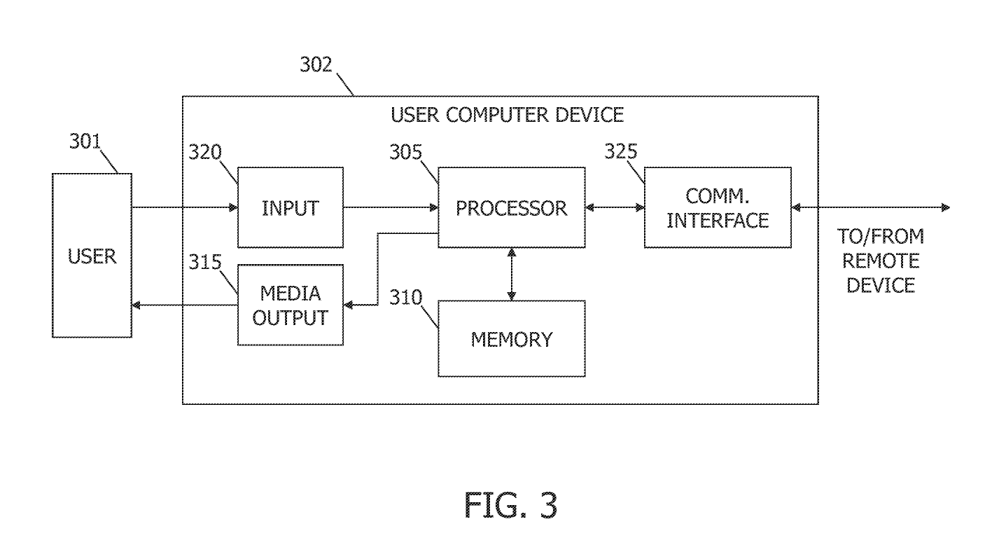

FIG. 3 illustrates an example configuration of client system 214 shown in FIG. 2, in accordance with one embodiment of the present disclosure. User computer device 302 is operated by a user 301. User computer device 302 may include, but is not limited to, client systems 214 and data sources 222 (both shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. The output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as CIC server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from CIC server system 212. A client application allows user 301 to interact with, for example, CIC server system 212. For example, instructions may be stored by a cloud service, and the output of the execution of the instructions sent to the media output component 315.

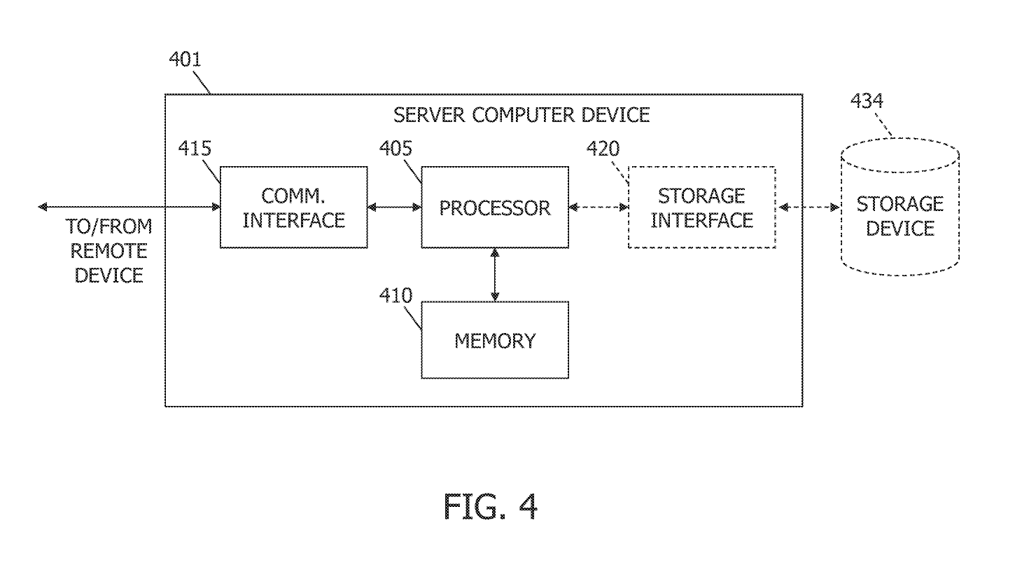

FIG. 4 illustrates an example configuration of a server system shown in FIG. 2, in accordance with one embodiment of the present disclosure. Server computer device 401 may include, but is not limited to, CIC server system 212 and database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, CIC server system 212, or data source 222 (all shown in FIG. 2). For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

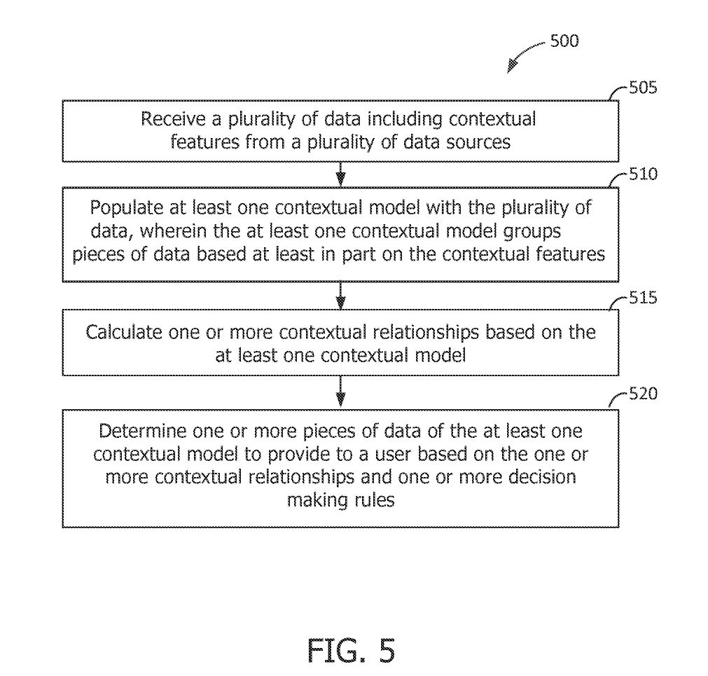

Processor 405 executes computer-executable instructions for implementing aspects of the disclosure. In some embodiments, the processor 405 is transformed into a special purpose microprocessor by executing computer-executable instructions or by otherwise being programmed. For example, the processor 405 is programmed with instructions such as illustrated in FIG. 5.

FIG. 5 is a flow chart of a process 500 for collating relevant information to assist a user in a decision-making process using system 100 shown in FIG. 1 and system 200 shown in FIG. 2. Process 500 may be implemented by a computing device, for example CIC server system 212 (shown in FIG. 2).

In the example embodiment, CIC server system 212 receives 505 a plurality of data including contextual features from a plurality of data sources 222, shown in FIG. 2. CIC server system 212 populates 510 at least one contextual model with the plurality of data. In the example embodiment, the at least one contextual model is pre-generated and populated with data and CIC server system 212 continually updates the data in the at least one contextual model from the data received from data sources 222. As described above, the at least one contextual model may include additional layers of contextual models, where the higher level contextual models 120 (shown in FIG. 1) are based on the adjacent lower level contextual models, such as extensible contextual model 110 shown in FIG. 1.

CIC server system 212 calculates 515 one or more contextual relationships 130 (shown in FIG. 1) based on the at least on contextual model. CIC server system 212 determines 520 one or more pieces of data of the at least one contextual model, which are provided to a user based on the one or more contextual relationships 130 and one or more decision making rules. In the example embodiment, the decision making rules are a part of predictive information model 140 (shown in FIG. 1) based on the decision making process. CIC server system 212 is configured to provide contextual data to the user, where the provided data is relevant to the decision making process of the user.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The implementations described herein relate to systems and methods for providing situational awareness of airline operations. More specifically, a contextual information collating (“CIC”) server system receives a plurality of data from a plurality of data sources. The plurality of data includes real-time data and further includes contextual features. The CIC computer system generates a contextual model with the plurality of data including the contextual features. In the example embodiment, the contextual model is previously generated and the CIC computer system uses the plurality of data to update the contextual model. The CIC computer system generates an advanced (or higher level) contextual model from the original (or lower level) contextual model. In the example embodiment, the CIC computer system generates the advanced data contextual model based on the lower level contextual model without directly accessing the raw data from the plurality of data sources. The CIC computer system determines one or more contextual relationships between data points (also known as data artifacts) based on the advanced contextual model. Contextual relationships are real-time spatial relationships such as distance or travel time between two individuals or units. The CIC computer system determines the information that needs to be provided to the user based on a predicting which pieces of information are important to the user's decision-making process. The CIC computer system provides the predicted context-enriched data to the user that is originally based on the real-time data received from the plurality of data sources.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for collating relevant information to assist a user in a decision-making process, the method implemented using a contextual information collating (CIC) server system in communication with a memory, the method comprising:
receiving, from a plurality of data sources, a plurality of pieces of data including contextual features;
populating at least one contextual model with the plurality of pieces of data, wherein the at least one contextual model groups pieces of data based at least in part on the contextual features;
calculating, by the CIC server system, one or more contextual relationships based on the at least one contextual model; and
determining, by the CIC server system, one or more pieces of data of the at least one contextual model to provide to a user based on the one or more contextual relationships and one or more decision making rules.

2. A method in accordance with claim 1, further comprising:
associating a confidence score with at least one piece of data of the plurality of pieces of data; and
filtering the at least one contextual model based on the confidence score associated with the at least one piece of data.

3. A method in accordance with claim 2, further comprising receiving the confidence score from the user.

4. A method in accordance with claim 3, wherein the user is a first user and the confidence score is a first confidence score, and further comprising:
receiving a second confidence score from a second user;
filtering the at least one contextual model based on the first confidence score for the first user; and
filtering the at least one contextual model based on the second confidence score for the second user.

5. A method in accordance with claim 1, further comprising generating at least one higher level contextual model based on the at least one contextual model, wherein the at least one higher level contextual model further limits pieces of data based at least in part on the contextual features.

6. A method in accordance with claim 5, wherein data for the at least one higher level contextual model is received directly from the at least one contextual model.

7. A method in accordance with claim 1, further comprising providing, to a user, the one or more determined pieces of data.

8. A method in accordance with claim 1, wherein determining one or more pieces of data further comprises:
receiving, from a user, a selection of a decision to make; and
determining the one or more decision making rules based on the selected decision.

9. A method in accordance with claim 1, wherein at least one of the one or more contextual relationships is a temporal spatial relationship.

10. A method in accordance with claim 1, wherein the plurality of pieces of data includes hard data and soft data.

11. A contextual information collating (CIC) server system used to collate relevant information to assist a user in a decision-making process, said CIC server system comprising a processor coupled to a memory device, said processor programmed to:
receive, from a plurality of data sources, a plurality of pieces of data including contextual features;
populate at least one contextual model with the plurality of pieces of data, wherein the at least one contextual model groups pieces of data based at least in part on the contextual features;
calculate one or more contextual relationships based on the at least one contextual model; and
determine one or more pieces of data of the at least one contextual model, which is provided to a user based on the one or more contextual relationships and one or more decision making rules.

12. The CIC server system of claim 11, wherein the at least one processor is further programmed to:
associate a confidence score with at least one piece of data of the plurality of pieces of data; and
filter the at least one contextual model based on the confidence score associated with the at least one piece of data.

13. The CIC server system of claim 12, wherein the at least one processor is further programmed to receive the confidence score from the user.

14. The CIC server system of claim 13, wherein the user is a first user and the confidence score is a first confidence score, and wherein the at least one processor is further programmed to:
receive a second confidence score from a second user;
filter the at least one contextual model based on the first confidence score for the first user; and
filter the at least one contextual model based on the second confidence score for the second user.

15. The CIC server system of claim 11, wherein the at least one processor is further programmed to generate at least one higher level contextual model based on the at least one contextual model, wherein the at least one higher level contextual model further limits pieces of data based at least in part on the contextual features.

16. The CIC server system of claim 15, wherein data for the at least one higher level contextual model is received directly from the at least one contextual model.

17. The CIC server system of claim 11, wherein the at least one processor is further programmed to provide, to a user, the one or more determined pieces to data.

18. The CIC server system of claim 11, wherein the at least one processor is further programmed to:
receive, from a user, a selection of a decision to make; and
determine the one or more decision making rules based on the selected decision.

19. A method in accordance with claim 1, wherein the plurality of pieces of data includes hard data and soft data.

20. At least one non-transitory computer-readable storage media having computer-executable instructions embodied thereon, wherein when executed by at least one processor, the computer-executable instructions cause the at least one processor to:
receive, from a plurality of data sources, a plurality of pieces of data including contextual features;
populate at least one contextual model with the plurality of pieces of data, wherein the at least one contextual model groups pieces of data based at least in part on the contextual features;
calculate one or more contextual relationships based on the at least one contextual model; and
determine one or more pieces of data of the at least one contextual model to provide to a user based on the one or more contextual relationships and one or more decision making rules.
